(19) United States
(12) Patent Application Publication
(10) Pub. No.: US 2004/0133498 A1
(43) Pub. Date: Jul. 8, 2004

(54) System and method for electronic quotation collaboration over internet

(75) Inventors: Chia-Shun Yeh, Taichung (TW); Shiao-Jong Hu, Hsin-Chus (TW); Ing-Chin Tsen, Hsinchu City (TW); Sing-Yi Lon, Hsinchu (TW)

Correspondence Address: GEORGE O. SAILE & ASSOCIATES, 28 DAVIS AVENUE, POUGHKEEPSIE, NY, 12603, US

(73) Assignee: Taiwan Semiconductor Manufacturing Company

(21) Appl. No.: 10/338,123

(22) Filed: Jan. 7, 2003

(51) Int. Cl. G06F 17/60

(52) U.S. Cl. 705/37

(57) ABSTRACT

A system and method for electronic quotation collaboration over the Internet. It is integrated with the corporate purchasing computer system and buyers can be automatically and periodically notified of an optimum time to issue a Request For Quotations for specific needed materials. Buyers can then easily post this Request for Quotations on a private, secure corporate Web site that acts as an electronic marketplace where buyers and related vendors can negotiate quotations. Related vendors are automatically notified by e-mail of the Request For Quotations and asked to respond on the Web site. After quotation negotiation, the system can generate a price analysis report using past quotation information. Buyers and managers can then use this report in their decision-making process. Quotations are automatically updated. Related information records in the corporate computer system are automatically updated as well. The entire process is automatically logged and easily tracked.

### BACKGROUND OF THE INVENTION

1. Field of Invention

This invention relates generally to obtaining quotations in the procurement process and, more particularly, to an automated system and method involving electronic quotation collaboration in a marketplace environment on the Internet.

2. Description of Related Art

There is a large amount of procurement necessary in industry today requiring the involvement of numerous personnel. Part of the life cycle of the procurement process is the bid or quotation process. The many people involved exchange constantly-changing information in various forms such as specifications, availability, and current pricing.

In the semiconductor industry, for example, billions of dollars are spent annually for procuring parts and materials necessary for keeping the manufacturing lines running continuously at peak performance. Any disruption in supply can stop a process and produce a backup in production throughout the facility. Requirements for materials change with the type of work requested by customers. Keeping all the potentially-needed materials on hand would increase costs and decrease competitiveness. It is more cost effective to start the quotation process with the correct amount of lead time to have materials and supplies available to the manufacturing plant when needed. Having several suppliers bidding not only reduces the chance of an item not being available, but also keeps costs down through competition. Getting the best value is always important to keeping manufacturing competitive.

In a continuous manufacturing environment, the current systems and methods of soliciting and confirming quotations often have high operational costs, long process cycle times, no analytic information for price negotiation, and no automatic log tracking. They do not meet manufacturing's need today for an automatic, fast, and reliable method. Specifically, buyers passively checking for optimum times to request quotations (allowing correct lead times) for a plurality of purchases can be a complex and time-consuming task. Often correct lead times are missed with the result of not having materials or supplies available at just the right time. Under the current method, Requests For Quotations (RFQ's) are made by paper letter, phone calls, e-mail, FAX and FTP (File Transfer Protocol) file exchange. Again, this is a very manual and time-consuming process. The cycle time for a Request For Quotations (RFQ) is frequently long, and often there is not enough information available for informed price negotiation and decision making. The result can be delays and costly, unnecessary overpayment for goods.

In the current method it is difficult to keep track of a variety of data, suppliers, quotations, etc. and keep information records updated. Manual tracking of the entire process is open to human updating delays and errors, especially with so many people involved. Schedule is yet another problem. For example, if a low bid was dependent on shipping the materials within a week, the bid must be analyzed and acted on quickly. Currently, manual maintenance of quotations and a manual communication process makes this very difficult. More manpower is needed for the manual processes in order to shorten cycle time and get the tasks completed. This translates into higher operational costs plus there could be idle paid employees in a low-volume RFQ time who need to be retained for the high-volume times.

The current systems and methods of getting quotations are plagued by long processing times, high people and operation costs, higher risk of human delay and errors, lack of analytical information for price negotiation and decision making, longer communication times with vendors, and lack of a computer log of the entire process for easy tracking. People-intensive operations such as passive information record queries and manual quotation and information record maintenance further plaque the current methods.

U.S. Pat. No. 5,842,178 (Giovannoli) describes a computerized quotation system and method forming a computer-based network. In U.S. Pat. No. 6,295,513 (Thackston) a network-based system for the manufacturing of parts is described. U.S. Pat. No. 5,917,912 (Ginter et al.) provides a system and method for secure transaction management and electronic rights protection. In U.S. Pat. No. 5,758,329 (Wojcik et al.) a system for managing customer orders using software is described. U.S. Pat. No. 6,195,646 (Grosh et al.) describes a system and method for facilitating the valuation and purchase of information and price. In U.S. Pat. No. 6,226,675 (Meltzer et al.) a participant server which processes electronic documents for commerce in trading partners' networks is described.

### SUMMARY OF THE INVENTION

This invention's overall objective is to provide a system and method for quotation collaboration by automating the bid process of procurement and providing a Web marketplace in which buyers and vendors can negotiate quotations for material purchases. A more specific objective is to actively perform automated checks of predetermined information records within a centralized computer system to determine when records expire according to their parameters and need to be acted on with an RFQ. Additionally, it is an objective to provide an automatic means to periodically notify buyers of these materials needing RFQ's.

Another objective is having an electronic means for buyers to post RFQ's in a portal accessible to related vendors. This can be an Internet Web Portal where related vendors can have easy access through their common browsers. In connection with this objective is the objective to have a notification method such as e-mail to alert related vendors of new RFQ's being placed on the Web Portal. Another key objective is to use this Web site as an electronic marketplace for quotation price negotiation between the buyers and the vendors. This marketplace is secure and private and allows bidding from each related vendor over a set time period.

Another objective is to generate a price comparison analysis between the RFQ responses and previous quotation and usage data of a set period of time. Still another objective is for management to make acceptance decisions taking this price comparison analysis into consideration. Another objective is for buyers to electronically confirm the quotations. It is another objective to automatically update the centralized computer system with confirmed quotation information, and still another to automatically log the entire process for easy tracking. The final objective is to provide a plurality of data forms within accessable databases to facilitate automation of the system and method.

### BRIEF DESCRIPTION OF THE DRAWINGS

This invention will be described with reference to the accompanying drawings, wherein:

FIG. 1 is a flow diagram of the background in prior art.

FIG. 2 is a flow diagram of the system.

FIG. 3 is a block diagram of the ERP (Enterprise Resource Planning system) and Application Server and the specific modules they contain.

FIG. 4 is a flow diagram of the main electronic quotation process.

### DETAILED DESCRIPTION OF THE PREFERRED EMBODIMENT

This invention is a software system and method that provides electronic quotation collaboration using the Internet or other available networks and is integrated with an existing corporate Enterprise Resource Planning computer system (ERP). Buyers, those responsible for the procurement of parts and supplies, can be notified of the optimum time to post on-line RFQ's in an electronic marketplace Web environment in which quotation negotiation between buyer and vendor can take place.

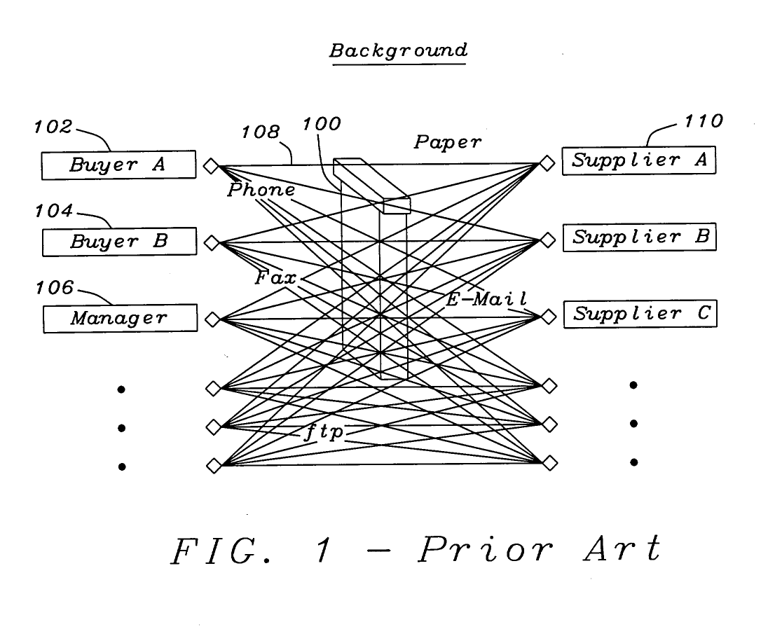

FIG. 1 shows the background and problems associated with quotation collaboration in prior art. In many large corporations many thousands of individual parts and supplies need to be continually procured to keep operations running. This is especially true in manufacturing where an available supply of parts is critical to keeping a production line running. Buyers have the job of obtaining these required parts and supplies at just the right time and at the best price possible from the company's suppliers. In the prior art, Buyer A 102 would create a RFQ for the item that is required to be purchased. He would then check the approved suppliers list and contact Supplier A, B, and C and others 110 for quotes on the item. This contact is done one by one using the phone, FAX, e-mail, FTP files, and even by mailing paper RFQ forms to the suppliers 108. This one-by-one approach creates a theoretical wall between the buyer and supplier 100. This gets more complex as Buyer B 104 does the same thing for another item and contacts many of the same suppliers separately in a similar manner. As the suppliers respond with bids based on the RFQ they likewise communicate in the same manner 108. As bids are negotiated with several suppliers, additional communications take place in a back and forth manner until a bid is approved, usually by a manager 106 authorized to do this.

Considering that many large corporations have more than two thousand suppliers they can order from, tremendous manpower is needed to make this process work. Buyers must keep track of each RFQ to ensure that bids are forthcoming. They must collect the bids and usually with a manager's approval determine which one to choose. With multiple people involved, there is a greater chance of human error and delays. If a bid is not handled correctly by the buyer, lead time in obtaining materials may be lost with the result of idle production lines because materials are unavailable. Because manual recording of the quotation process is also open to human error and delay, tracking can be difficult. With limited tracking, questions or concerns from either the corporation or vendor regarding a bid may be more difficult to resolve, resulting in dissatisfaction that might taint future dealings.

This is an expensive, long, labor-intensive process that is open to many errors and lacks easy, automatic access to a variety of data for analytic and efficiency purposes. Without easy tracking from electronic logs, it can be hard to resolve problems when they happen or even to go back through a set of transactions to analyze what happened. A better method is required which this invention provides.

This invention creates an Electronic Quotation Collaboration (EQC) system that connects its users and components using the Internet or other networks. The system is integrated with the current corporate computer system that handles and controls business activity and is sometimes called the Enterprise Resource Planning system (ERP). This integration is accomplished by creating system components using common Internet capabilities and using the World Wide Web (Web) and common browsers as the user interface.

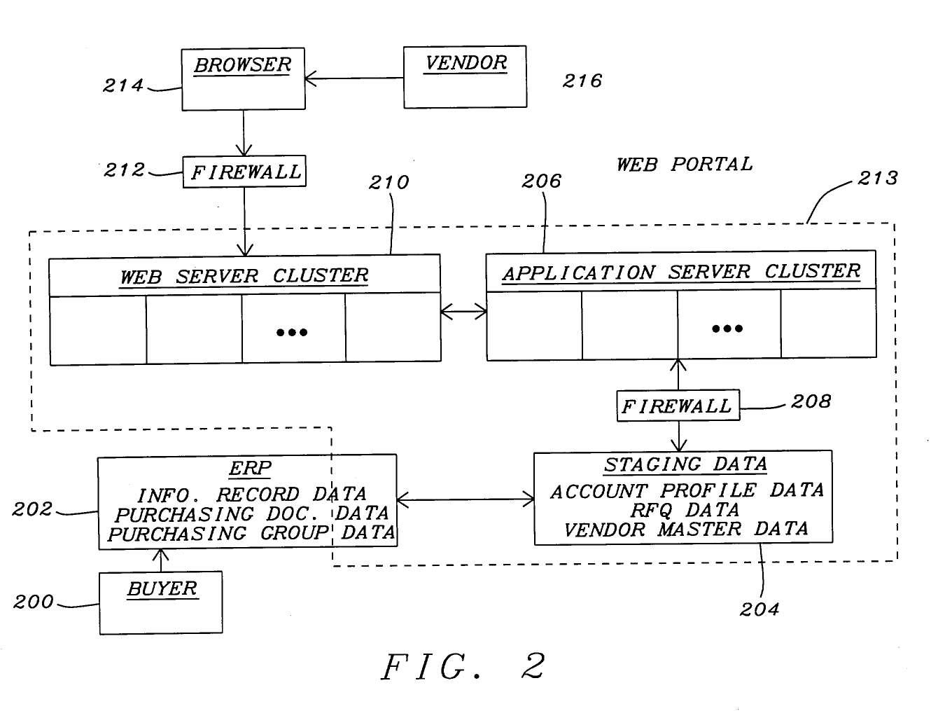

An overview of the EQC system is shown in FIG. 2. The buyer 200, or original requester of the items to be purchased, interfaces with the system through the normal ERP interface 202. The ERP 202 contains previously-entered information record data, purchasing document data, and purchasing group data. The Staging Database 204 contains account profile data, RFQ data, and vendor master data. Having access to these multiple and varied forms of data adds comprehensiveness and efficiency to the automated system and method. The ERP records the request from purchasing as an information record with predefined parameters including an optimum time to alert the buyer to begin RFQ's. The less-secure staging database contains an RFQ table with material, vendor, purchasing, account, and RFQ information that can be accessed by vendors. Vendors are notified of an RFQ posting by e-mail and asked to respond on the Web site. This data is protected by a firewall 208 to ensure that the data is not compromised by Web hackers. The Application Server Cluster 206 is where the primary software that runs the system resides. It is through here that the RFQ is posted in an electronic marketplace environment and made available to vendors and suppliers so that they can negotiate quotes in response to the RFQ.

This interfaces with the Web Server Cluster 210 that provides access to the Internet and Web. Another firewall 212 is provided for protection of the Web Server from the Internet. Access to the EQC system is by using a standard browser 214, with which the vendor 216 enters his information using a formatted Web page that is provided.

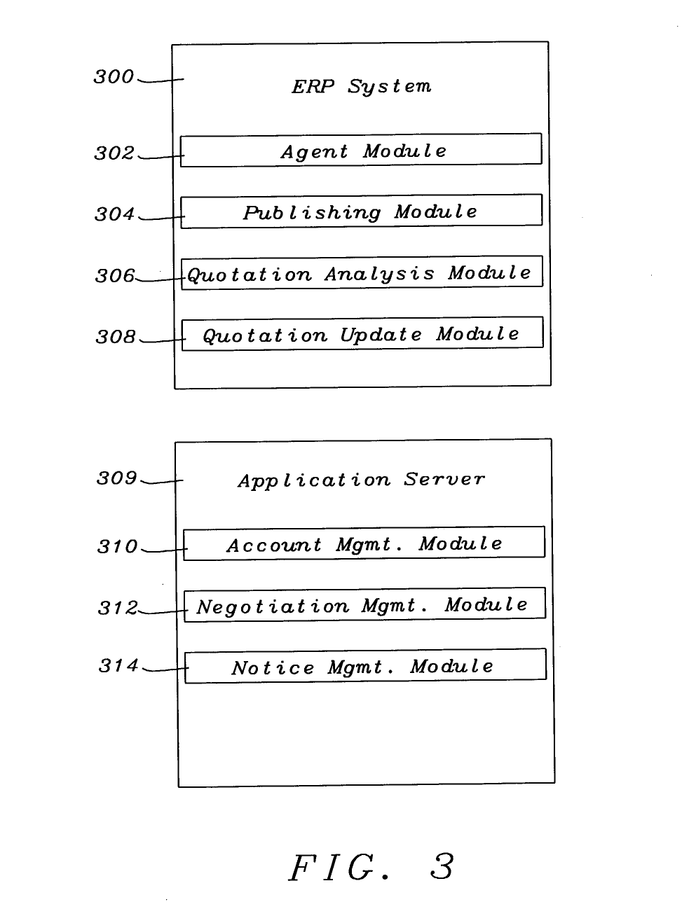

The EQC system is composed of several program modules, some of which are on the ERP system and some on the Application Server Cluster. FIG. 3 shows the ERP system 300 and the Application Server 309 in block form. Four modules are within the ERP system. In the Agent Module 302, an agent program periodically checks information records predefined with material number, material number used by vendor, vendor code, material group, and information record expired lead time. Purchasing groups have done material forecasts and analyzed what will be needed for orders. Because materials take varying amounts of time to obtain, an associated expired lead time is assigned by the purchaser to the information record and is calculated as expired data <current date+expired lead time. The agent program determines which information records have expired and notifies the buyers by e-mail or other alert methods. The buyer then runs a program in the Publishing Module to post the RFQ to the Web Portal 213 of the private corporate Web Server 210 through the Application Server 206. The Publishing Module 304, meanwhile, has inserted data from the expired information record based on the predefined parameters into an RFQ table in the staging database and has triggered the Notice Management Module 314 in the Application Server. Buyers can generate a price comparison report in the Quotation Analysis Module that compares the negotiated quotation response with recent previous quotation and usage data from a set period of time by material number. Once the purchase is approved, the buyers confirm the quotation in the Quotation Update Module 308, and the Quotation Update Module automatically updates the information record and RFQ table.

In the Application Server 309 there is an Account Management Module 310 which controls vendor access to the EQC. Vendors are given ID's and passwords that they use to obtain access to the Web site using their Web browsers. The Negotiation Management Module 312 creates an electronic marketplace for time-limited price negotiation between buyers and vendors in response to the RFQ. This enterprise Web site is open only to approved vendors. The Notice Management Module 314 receives notice of a new RFQ from the Publishing Module 304 and alerts the related vendors by e-mail or other method that there is a new item up for bid and to go to the Web site for quotation negotiation. Related vendors are determined from the vendor master data in the staging database.

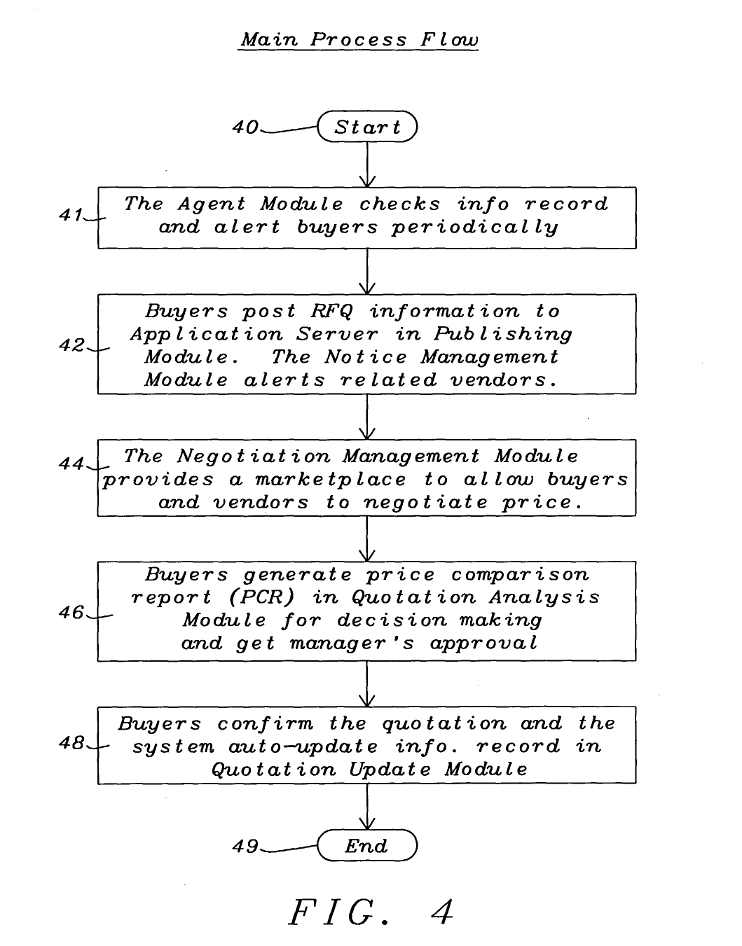

The EQC system automates much of the quotation process with such features as computerized information record checks, automatic notification, an electronic market place, computer analysis, and automatic updating methods. This automation results in a more reliable and cost-effective system and method to obtain materials at the appropriate time at the best price. FIG. 4 shows the main process flow. As Purchasing has determined what supplies or parts are needed when and established parameters and expiration lead times for resulting information records in the ERP system, the process starts 40. The Agent Module 41 in the ERP then periodically checks information records and alerts buyers to those expired ones needing RFQ's issued. The buyers then run a program in the Publishing Module to post the RFQ to the Web Portal of the private Web site 42, and the Notice Management module 44 alerts related vendors 42. The Application Server Cluster determined which vendors and suppliers were related to this RFQ item from the staging database's vendor master data. It automatically notified them by e-mail and asked them to respond with their quotations on the Web site. A module called the Negotiation Management Module provides an electronic marketplace to allow buyers and authorized vendors to negotiate price 44. As quotations are received, buyers can generate price comparison reports in a Quotation Analysis Module 46 to help them in their decision making and to get their managers' approval for the final purchase. Buyers then confirm the quotation and the system Quotation Update Module automatically updates information records and the RFQ table 48. The entire process has been automatically logged and can be easily tracked. The main process is ended 49.

The method of the invention provides advantages over the prior art in that the system automatically and actively reminds buyers about expiring information reords that need RFQ's issued, provides for instantaneous RFQ posting and notification via the internet (savings of two days per item), provides an electronic marketplace for price negotiation, automatically updates quotations (savings of 70% man hours), automatically updates information records (savings of 80% of man hours), and provides online and overall price comparison analysis and automatically logs the entire process. This translates into less manpower needed, increased productivity, reduced operational costs and cycle time, smoother dealings with vendors, decision support for price negotiation results, and easy tracking.

While the invention has been particularly shown and described with reference to preferred embodiments thereof, it will be understood by those skilled in the art that various changes in form and details may be made without departing from the spirit and scope of the invention.

What is claimed is:

1. A method for automating the bid process of procurement, comprising:
a. providing an automated means to periodically alert buyers to post Requests for Quotations for needed materials;
b. providing an electronic marketplace for said buyers and related vendors to negotiate quotations given in response to said Requests For Quotations;
c. providing a programmed means to generate a price comparison analysis between the negotiated quotation response to said requests for quotations and previous quotation and usage data;
d. providing update means for said buyers to electronically confirm the quotations;
e. providing a plurality of data forms within accessible databases to facilitate automation of the method.

2. The method for automating the bid process of procurement of claim 1, wherein predetermined information has its parameters and expired lead time set in the Agent Module and is checked periodically in said an Module.

3. The method for automating the bid process of procurement of claim 2, wherein information records contained on a centralized computer system contain detailed information on needed materials to allow said Agent Module to alert said buyers automatically of the optimum time to buy said needed materials.

4. The method for automating the bid process of procurement of claim 3, wherein timing of an alert of said buyers is calculated by factoring in lead time needed to obtain said needed material.

5. The method for automating the bid process of procurement of claim 4, wherein said alert of said buyers is accomplished by e-mail or other alert method.

6. The method for automating the bid process of procurement of claim 1, wherein said buyers using the Publishing Module post said Requests For Quotations over the internet onto a Web Portal that is accessible by said related vendors.

7. The method for automating the bid process of procurement of claim 6, wherein the said Web Portal is contained on a Web Server that creates an electronic marketplace in a Negotiation Management Module for said related vendors and said buyers to negotiate said quotations.

8. The method for automating the bid process of procurement of claim 7, wherein an Account Management Module controls users' authorization to log in with required ID's and passwords.

9. The method for automating the bid process of procurement of claim 7, wherein said Web Server and an Application Server provide said electronic marketplace as a secure said Web Portal secured by firewalls.

10. The method for automating the bid process of procurement of claim 6, wherein said related vendors are notified of said Requests For Quotations automatically by said e-mail or said other alert method by the Notice Management Module.

11. The method for automating the bid process of procurement of claim 7, wherein said related vendors can negotiate said quotations within said electronic marketplace by using their common Internet browsers.

12. The method for automating the bid process of procurement of claim 7, wherein the negotiation of said quotations within said electronic marketplace is limited in time.

13. The method for automating the bid process of procurement of claim 1, wherein said buyers generate said price comparison analysis in the Quotation Analysis Module for decision making and getting management approval.

14. The method for automating the bid process of procurement of claim 1, wherein said quotations are confirmed and said information records and Requests For Quotes table are updated by the Quotation Update Module.

15. The method for automating the bid process of procurement of claim 1, wherein logging of the entire bid process is done to a database.

16. The method for automating the bid process of procurement of claim 1, wherein information record data, purchasing document data, purchasing group data, account profile data, Request For Quotes data, and vendor master data are accessed from the ERP and Staging Database.

17. A system for automating the bid process of procurement, comprising of:
a. a means to automatically alert buyers to post Requests For Quotations for needed materials;
b. a means to provide an electronic marketplace for price negotiation between said buyers and said related vendors of responses to said Requests For Quotations;
c. a means to generate a price comparison analysis between the negotiated response to said Requests For Quotations and previous quotation and usage data;
d. a means to automatically update said centralized computer system with confirmed quotation information;
e. a means to store a plurality of data forms

18. The system for automating the bid process of procurement of claim 17, wherein information records in a central computer system contain detailed information on said needed materials to allow the Agent Module to automatically and periodically check them and automatically alert said buyers of the optimum time to buy said needed materials.

19. The system for automating the bid process of procurement of claim 18, wherein timing of the alert of said buyers by e-mail or other alert method is calculated by factoring in lead time required to obtain said needed materials.

20. The system for automating the bid process of procurement of claim 17, wherein said buyers using a Publishing Module can post said Requests For Quotations over the Internet onto a Web Portal that is accessible by said related vendors.

21. The system for automating the bid process of procurement of claim 20, wherein said Web Portal is contained on a Web Server that creates said electronic marketplace in the Negotiation Management Module for said related vendors to negotiate quotations.

22. The system for automating the bid process of procurement of claim 21, wherein said Web Server and an Application Server provide said electronic marketplace as a secure said Web Portal which is secured by firewalls and required ID's and passwords that are controlled by an Account Management Module.

23. The system for automating the bid process of procurement of claim 17, wherein said related vendors are notified of said Requests For Quotations automatically by e-mail or other alert method by the Notice Management Module.

24. The system for automating the bid process of procurement of claim 17, wherein said related vendors can negotiate said quotations within said electronic marketplace by using their common Internet browsers for a limited time period.

25. The system for automating the bid process of procurement of claim 17, wherein said buyers generate said price comparison analysis in the Quotation Analysis Module for decision making and getting management approval.

26. The system for automating the bid process of procurement of claim 17, wherein said quotations are confirmed and said information records and Requests For Quotes table are updated by the Quotation Update Module.

27. The system for automating the bid process of procurement of claim 17, wherein logging of said entire bid process is done to a database.

28. The system for automating the bid process of procurement of claim 17, wherein information record data, purchasing document data, purchasing group data, account profile data, Request For Quotations data, and vendor master data are accessed from the ERP and Staging Database.
